(19) United States
(12) Patent Application Publication
(10) Pub. No.: US 2010/0288301 A1
(43) Pub. Date: Nov. 18, 2010

(54) REMOVING CONTAMINANTS FROM AN ELECTROLESS NICKEL PLATED SURFACE

(76) Inventors: Hui Hwang Kee, Singapore (SG); Shaoyong Liu, Singapore (SG); Jing Fang Pan, Singapore (SG); Yi Zhao Yao, Singapore (SG)

Correspondence Address: HITACHI C/O WAGNER BLECHER LLP, 123 WESTRIDGE DRIVE, WATSONVILLE, CA, 95076, US

(21) Appl. No.: 12/466,638

(22) Filed: May 15, 2009

(51) Int. Cl. B08B 3/08; C23G 1/00; C23G 1/02

(52) U.S. Cl. 134/1; 134/26; 134/30; 134/95.1

(57) ABSTRACT

Removing contaminants from an electroless nickel (EN) plated surface. A surface of an EN plated object is washed in a first deionized water to remove a first portion of surface contaminants. The surface is immersed into a chemical solution wash for a pre-determined duration to remove nickel phosphate particles from the surface, wherein the chemical solution wash comprises at least one type of chelating agent dissolved in a solvent. The chemically washed surface is then washed in a second deionized water to remove a second portion of the surface contaminants.

### FIELD

The field of the present technology relates generally to computing systems. More particularly, embodiments of the present technology relate to hard disk drives.

### BACKGROUND

In the hard disk drive (HDD) industry, electroless nickel (EN) plating is intensively used during manufacture of (HDD) components. There are several advantages to using EN plating. EN plating if free from flux-density and power supply issues. It also provides an even deposit regardless of work piece geometry. Moreover, EN plating is capable of being deposited on non-conductive surfaces. During manufacturing, it may be used as a magnetically neutral base coating on HDDs prior to finishing with a magnetic read/write iron oxide coating.

### BRIEF DESCRIPTION OF THE DRAWINGS

FIG. 1 is a block diagram of an example system for removing contaminants from a surface of an electroless nickel plated object, in accordance with embodiments of the present technology.

FIG. 2 is a flowchart of an example method for removing contaminants from a surface of an electroless nickel plated object, in accordance with embodiments of the present technology.

FIG. 3 is a flowchart of an example chemical washing method for improving electroless nickel plated hard disk drive component cleanliness, in accordance with embodiments of the present technology.

The drawings referred to in this description should be understood as not being drawn to scale except if specifically noted.

### DETAILED DESCRIPTION

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

The discussion will begin with an overview of embodiments of the present technology for removing contaminants from a surface of an electroless nickel (EN) plated object. The discussion will then focus on an example architecture and example methods of the present technology that remove contaminants from a surface of an electroless nickel plated object.

### Overview

Embodiments in accordance with the present technology pertain to a system for removing contaminants, such as nickel phosphate particles, from a surface of an EN plated object. During the manufacture of an EN plated hard disk drive (HDD) component, nickel phosphate particles may break off and remain on the HDD component. These nickel phosphate particles may be observed under high magnitude microscope on the EN plated HDD component. If these nickel phosphate particles remain on the EN plated HDD component, they may drop off and cause a scratch on the disk or head during HDD operation. Many times, these disk and/or head scratches result in HDD failure.

More particularly, in one embodiment of the present technology, a surface of the EN plated HDD component is washed with a first deionized water wash to remove a first portion of surface contaminants from the EN plated HDD component. Then, this washed surface is chemically washed with at least one chelating agent dissolved in a solvent. This chemical solution wash removes any nickel phosphate particles on the EN plated HDD component. Next, the surface of the EN plated HDD component is washed with a second deionized water wash to remove a second portion of surface contaminants from the EN plated HDD component. The surface is then dried. The EN plated HDD component is then baked.

This method for washing contaminants from a surface of an EN plated HDD component cleans contaminants, including nickel phosphate, from the EN plated HDD component surface. By removing these nickel phosphate particles from the EN plated HDD component surface, HDD failure associated with EN plated objects is reduced. Therefore, nickel phosphate particle related HDD failures can be eliminated at a HDD manufacturing site and HDD customer sites.

### Example Architecture

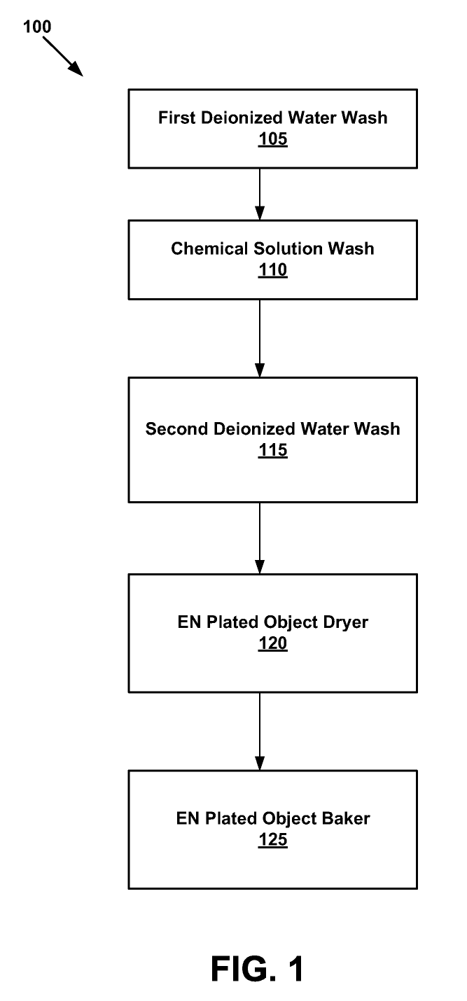

FIG. 1 is a block diagram of an example system 100 for removing contaminants from a surface of an EN plated object, in accordance with embodiments of the present technology. System 100 includes first deionized water wash 105, chemical solution wash 110, and second deionized water wash 115. In further embodiments of the present technology, system 100 includes EN plated object dryer 120 and EN plated object baker 125.

Referring still to FIG. 1, first deionized water wash 105, chemical solution wash 110, and second deionized water wash 115 are configured to receive a surface of an EN plated object and/or a portion of the EN plated object. In one embodiment, the portion of the EN plated object is the whole of the EN plated object. In another embodiment, the portion of the EN plated object is less than the whole of the EN plated object. In one embodiment, the EN plated object is an HDD component.

In one embodiment, the chemical wash 110 comprises at least one type of chelating agent dissolved in a solvent. In one embodiment, the solvent is water. In another embodiment, the at least one type of chelating agent is a nitrogen-containing carboxylic acid. In another embodiment, the at least one type of chelating agent is selected from the group of chelating agents consisting of: ethylenediaminetetraacetic acid (EDTA); tetraammonium salt of EDTA; tetrasodium salt of EDTA; tetrapotassium salt of EDTA; diammonium salt of EDTA; disodium salt of EDTA; and dipotassium salt of EDTA.

### Example Operation

More generally, in embodiments in accordance with the present technology, System 100 is utilized for removing contaminants, such as nickel phosphate particles, from a surface of an electroless nickel (EN) plated object. Remnants of nickel phosphate particles may cause disk and head scratches, resulting in disk failure. Current methods of washing particles from hard disk drive (HDD) components, such as aqueous washing, do not remove these nickel phosphate particles. However, system 100 is configured for removing these nickel phosphate particles as well as other contaminants, thus decreasing the risk of disk failure caused by contaminants.

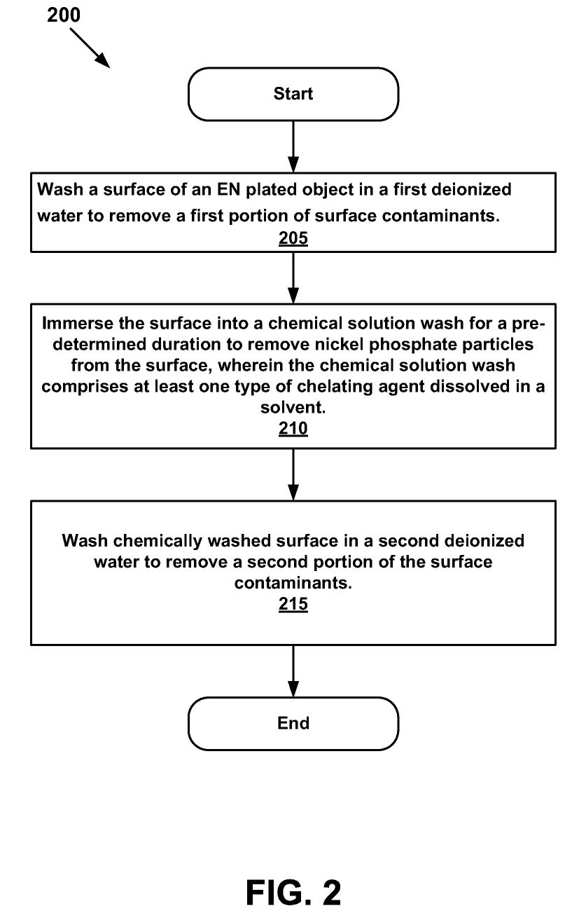

FIG. 2 is a flowchart of an example method for removing contaminants from a surface of an electroless nickel plated object, in accordance with embodiments of the present technology. Referring to 210 FIG. 2, in one embodiment, a surface of an EN plated object is washed in first deionized water wash 105 to remove a first portion of surface contaminants. A “first portion of surface contaminants” refers to any amount of surface contaminants, including zero surface contaminants. For example, other than nickel phosphate particles, an EN plated object may have contaminants “A” on its surface. The first deionized water wash 105 is able to remove “x” number of surface contaminants, of surface contaminants “A”. However, of note, the first deionized water wash 105, in general, is not able to remove the nickel phosphate particles still remaining on a finished EN plated HDD component.

The second deionized water wash 115 is configured to remove a second portion of surface contaminants “A”. The “second portion” of surface contaminants refers to any amount of surface contaminants, including zero surface contaminants, relating to the “first portion” that was removed. For example, the “second portion” of surface contaminants that are removed can be measured as surface contaminants “A” minus first portion of surface contaminants removed, “x”. Thus, A−x=B (the second portion of surface contaminants removed). It is noted that it is possible that not all of surface contaminants “A” are removed all of the time. There may be some surface contaminants “A” left on the EN plated object, regardless of the surface contaminants exposure to first deionized water wash 105 and second deionized water wash 110.

Referring now to 210 of FIG. 2, after a surface of an EN plated object is washed in first deionized water wash 105, the surface of the EN plated object is immersed into chemical solution wash 110 for a predetermined duration to remove nickel phosphate particles from the surface. This pre-determined time may represent the time needed for removal of the nickel phosphate particles or a portion thereof.

As stated herein, in one embodiment, chemical solution wash 110 comprises at least one type of chelating agent dissolved in a solvent. In one embodiment, chemical wash solution 110 comprises a mixture of two or more types of chelating agents dissolved in water. In another embodiment, chemical wash solution 110 comprises a mixture of two or more types of chelating agents dissolved in a solvent other than water.

In one embodiment, the chemical solution wash 110 is maintained at a temperature corresponding to the at least one type of chelating agent. For example, a chelating agent may be able to remove surface contaminants more easily at a certain temperature or at a range of temperatures. Furthermore, in one embodiment, this temperature or range of temperatures may range from an ambient temperature to an elevated temperature.

In one embodiment, the pH value of chemical solution wash 110 is adjusted accordingly, so that the best washing efficiency of the surface of the EN plated object can be achieved. In another embodiment, ultrasonic agitation is utilized to quicken the method for removing contaminants. In one embodiment, a high frequency ultrasonic wash may remove smaller-sized particles. In another embodiment, a lower frequency ultrasonic wash may remove larger-sized particles.

Referring now to 215 of FIG. 2, in one embodiment, the chemically washed surface described herein of 210 of FIG. 2 is washed in second deionized water wash 115 to remove a second portion of the surface contaminants.

In one embodiment, the chemically washed EN plated object that was washed in second deionized water wash 115, and described in 215 of FIG. 2, is dried. In another embodiment, this dried chemically washed EN plated object is baked.

In one example of the present technology, an EN plated carriage comb with nickel phosphate particles remaining on its surface, is washed in a deionized water wash. Then, the EN plated carriage comb is immersed into a solution, for a few minutes, of 0.1M Na₂H₂EDTA dissolved in water, with a pH equal to 4-5, maintained at a temperature of 50 degrees Celsius, and ultrasonically agitated at 68 KHz. The EN plated carriage comb is then washed with a second deionized water wash. Next, the EN plated carriage comb is dried and then baked at 120 degrees Celsius for 1.5 hours. This washing process results in the quantitative removal of the nickel phosphate particles.

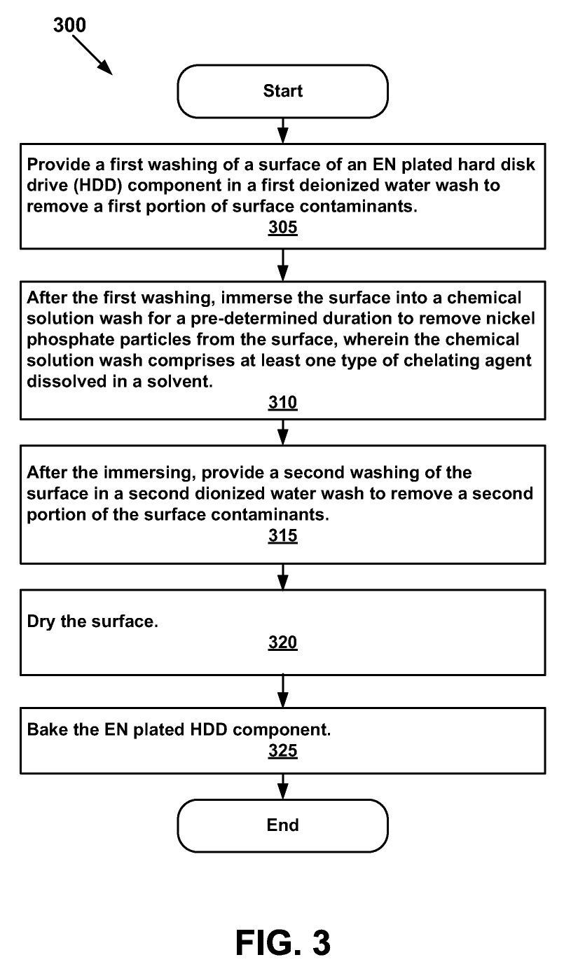

FIG. 3 is a flowchart of an example chemical washing method for improving EN plated hard disk drive component cleanliness, in accordance with embodiments of the present technology.

Referring to 305 of FIG. 3 and as described herein, in one embodiment of the present technology, a first washing of a surface of an EN plated HDD component in first deionized water wash 105 is provided to remove a first portion of surface contaminants. Referring to 310 of FIG. 3 and as described herein, in one embodiment of the present technology, after the first washing, the surface is immersed into chemical solution wash 110 for a pre-determined duration to remove nickel phosphate particles from the surface, wherein the chemical solution wash 110 comprises at least one type of chelating agent dissolved in a solvent.

Referring to 315 of FIG. 3 and as described herein, in one embodiment of the present technology, after the immersing of 310 of FIG. 3, a second washing of the surface in second deionized water wash 115 is provided to remove a second portion of the surface contaminants.

Furthermore, in one embodiment and as stated herein, the surface of the EN plated HDD component is dried. Then, in one embodiment and as stated herein, after the drying of the surface, the EN plated HDD component comprising the surface is baked.

Thus, embodiments of the present technology provide methods for cleaning an HDD component such that all nickel phosphate particles are removed. By removing these particles, the risk of HDD failure is reduced.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for removing contaminants from a surface of an electroless nickel (EN) plated object, said method comprising:
washing a surface of an EN plated object in a first deionized water to remove a first portion of surface contaminants;
immersing said surface into a chemical solution wash for a pre-determined duration to remove nickel phosphate particles from said surface, wherein said chemical solution wash comprises at least one type of chelating agent dissolved in a solvent; and
washing chemically washed surface in a second deionized water to remove a second portion of said surface contaminants.

2. The method recited in claim 1, further comprising:
after said washing said chemically washed surface in said second deionized water, drying said chemically washed surface.

3. The method recited in claim 2, further comprising:
after said drying said chemically washed surface, baking said EN plated object comprising said dried chemically washed surface.

4. The method recited in claim 1, further comprising:
maintaining said chemical solution wash at a temperature corresponding to said at least one type of chelating agent.

5. The method recited in claim 4, wherein said temperature ranges from an ambient temperature to an elevated temperature.

6. The method recited in claim 1, wherein said immersing said EN plated object into a chemical solution wash for a pre-determined duration, wherein said chemical solution comprises at least one type of chelating agent, further comprises:
utilizing a chemical solution wash comprising a mixture of two or more types of chelating agents dissolved in water.

7. The method recited in claim 1, wherein said immersing said EN plated object into a chemical solution wash for a pre-determined duration, wherein said chemical solution comprises at least one type of chelating agent, further comprises:
utilizing a chemical solution wash comprising a mixture of two or more types of chelating agents dissolved in a solvent other than water.

8. The method recited in claim 1, further comprising:
adjusting a pH value of said chemical solution wash to achieve better washing efficiency of said surface of said EN plated object.

9. The method recited in claim 1, further comprising:
utilizing ultrasonic agitation to quicken said method for removing said surface contaminants.

10. A system for removing contaminants from a surface of an electroless nickel (EN) plated object, said system comprising:
a first deionized water wash configured for removing a first portion of surface contaminants from a surface of an EN plated object;
a chemical solution wash configured for removing nickel phosphate particles from said surface of said EN plated object, said chemical solution wash comprising at least one type of chelating agent dissolved in a solvent;
a second deionized water wash configured for removing a second portion of said surface contaminants from a surface of chemically washed EN plated object.

11. The system of claim 10, further comprising:
an EN plated object dryer configured for drying a portion of said EN plated object.

12. The system of claim 10, further comprising:
an EN plated object baker configured for baking said EN plated object.

13. The system of claim 10, wherein said at least one type of chelating agent is a nitrogen-containing carboxylic acid.

14. The system of claim 10, wherein said at least one type of chelating agent is selected from a group of chelating agents consisting of: ethylenediaminetetraacetic acid (EDTA); tetraammonium salt of EDTA; tetrasodium salt of EDTA; tetrapotassium salt of EDTA; diammonium salt of EDTA; disodium salt of EDTA; and dipotassium salt of EDTA.

15. A chemical washing method for improving electroless nickel (EN) plated hard disk drive component cleanliness, said method comprising:
providing a first washing of a surface of an EN plated hard disk drive (HDD) component in a first deionized water wash to remove a first portion of surface contaminants;
after said first washing, immersing said surface into a chemical solution wash for a pre-determined duration to remove nickel phosphate particles from said surface, wherein said chemical solution wash comprises at least one type of chelating agent dissolved in a solvent;
after said immersing, providing a second washing of said surface in a second dionized water wash to remove a second portion of said surface contaminants;
drying said surface; and
baking said EN plated HDD component.

16. The method recited in claim 15, further comprising:
maintaining said chemical solution wash at a temperature corresponding to said at least one type of chelating agent.

17. The method recited in claim 15, wherein said temperature ranges from an ambient temperature to an elevated temperature.

18. The method recited in claim 15, immersing said surface into a chemical solution wash for a pre-determined duration to remove nickel phosphate particles from said surface, wherein said chemical solution wash comprises at least one type of chelating agent dissolved in a solvent, further comprises:
utilizing a chemical solution wash comprising a mixture of two or more types of chelating agents dissolved in water.

19. The method recited in claim 1, immersing said surface into a chemical solution wash for a pre-determined duration to remove nickel phosphate particles from said surface, wherein said chemical solution wash comprises at least one type of chelating agent dissolved in a solvent, further comprises:
utilizing a chemical solution wash comprising a mixture of two or more types of chelating agents dissolved in a solvent other than water.

20. The method recited in claim 1, further comprising:
adjusting a pH value of said chemical solution wash to achieve better washing efficiency of said surface of said EN plated object.
